(19) United States
(12) Patent Application Publication
(10) Pub. No.: US 2006/0216960 A1
(43) Pub. Date: Sep. 28, 2006

(54) Board-to-board connector

(76) Inventor: Chang Chi Chang, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/126,198

(22) Filed: May 11, 2005

(30) Foreign Application Priority Data
Mar. 22, 2005 (TW) 094108836

(51) Int. Cl. H01R 12/00

(52) U.S. Cl. 439/74

(57) ABSTRACT

A board-to-board connector consisting of a plug and a socket is disclosed. The plug includes a plurality of first transmit pins inserted through an insulated base. One end of the first transmit pins is connected with a first circuit board while the other end thereof is located on the insulated base. The plug comprises a plurality of second transmit pins, an insulator enclosing the main body of the second transmit pins that is separated from each other, and a shielding body covered the insulator. One end of the second transmit pins is connected with a second circuit board while the other end thereof is inserted into the insulated base of the socket for electrical connection with the first transmit pins. By the insulator and the shielding body, electromagnetic interference is suppressed and better quality of transmission is provided. Moreover, the manufacturing cost is reduced due to simple structure of the device and board-to-board connectors with various heights are produced easily.

### BACKGROUND OF THE INVENTION

The present invention relates to a connector, especially to a board-to-board connector with simple structure as well as electromagnetic interference suppression during high-speed transmission.

Along with the fast development of technology, high-tech products are constantly evolving and updated with new ones. Most of the products has high operational capability, compact volume, and high expansion capability. Thus there are board-to-board connectors with expansion capability and connection function disposed on circuit boards of the technology products for coupling and electrical connection between two circuit boards. And the main circuit board can add with an additional circuit board. However, most of the board-to-board connectors available now are with complicated structure and high manufacturing cost. Thus there are only some connectors with certain heights for users to choose. Moreover, accompanied with the increase of operation and transmission speed, electromagnetic interference is also raised. The high-speed board-to-board connectors still can't suppress the electromagnetic interference effectively so that the transmission quality is lowered.

Refer to FIG. 1 & FIG. 2, a conventional board-to-board connector is disclosed. As shown in FIG. 1, the connector is composed by a socket 10 and a plug 20. The socket 10 consists of a main body 13 that is an insulator disposed with a slot 16. A plurality of first transmit pins 19 extending to the bottom of the main body 13 is arranged between walls of the two inner sides of the slot 16. The plug 20 includes a main body 23 that is an insulator with a protrusion 26. A plurality of second transmit pins 29 extending to the bottom of the main body 23 is disposed on walls of two outer sides of the protrusion 26. The first transmit pins 19 and the second transmit pins 29 disposed on tow sides of the bottom of the main body 13, 23 respectively are used to connect with a first circuit board 30 and a second circuit board 40.

When users intend to connect the second circuit board 40 with the first circuit board 30, the protrusion 26 of the plug 20 inserts into the slot 16 of the socket 10 so as to make the second transmit pins 29 on walls of two outer sides of the protrusion 26 contact with the first transmit pins 19 on walls of two inner sides of the slot 16. Thus signals are transmitted between the first circuit board 30 and the second circuit board 40. The conventional socket 10 and the plug shown in figure have complicated structure and there are difficulties on disposition of the first transmit pins 19 and second transmit pins 29. Therefore, the production efficiency is reduced and the manufacturing cost is raised so when deciding the height of the board-to-board connector, the common height is chosen.

Refer to FIG. 3, another prior art of the board-to-board connector is disclosed. The board-to-board connector includes a socket 50 and a plug 60. The socket 50 consists of an insulated base 53 with a plurality of insertion hole 55 and a plurality of first transmit pins 59 thereof. One end of the first transmit pins 59 is connected with a first circuit board 30 while the other end thereof is located on the insertion hole 55. As to the plug 60, it consists of an upper fixing base 63 and a lower fixing base 66. A plurality of second transmit pins 69 is inserted through and disposed between the upper fixing base 63 and the lower fixing base 66. One end of the second transmit pins 69 is connected with a second circuit board 40 while the other end thereof is inserted into the insertion hole 55 of the socket 50 so as to electrically contact with the first transmit pins 59. Thus signals are transmitted between the first circuit board 30 and the second circuit board 40. Although structure of this embodiment is simplified, the electromagnetic interference still can't be suppressed or reduced during high-speed signal transmission so that transmission quality is affected.

Therefore, the present invention provides a board-to-board connector that has simple structure and easy manufacturing process so that the manufacturing cost is reduced dramatically. Moreover, the electromagnetic interference during high-speed transmission is reduced and suppressed so as to improve the transmission quality of signals.

### SUMMARY OF THE INVENTION

It is a primary object of the present invention to provide a board-to-board connector with features of simple structure, easy manufacturing process, and low manufacturing cost. Thus it's easy and convenient to produce board-to-board connectors with various heights. The production of board-to-board connectors has higher flexibility.

It is another object of the present invention to provide a board-to-board connector that suppresses electromagnetic interference effectively during high-speed transmission and further improves quality of high-speed transmission.

In order to achieve above objects, the present invention provides a board-to-board connector including a socket and a plug. The socket consists of an insulated base being inserted with a plurality of first transmit pins. One end of the first transmit pins is connected with a first circuit board while the other end thereof is located on the insulated base. The plug includes a plurality of second transmit pins, an insulator and a shielding body. The insulator encloses main body of the second transmit pins while the shielding body covers the insulator. One end of the second transmit pins is connected with a second circuit board and the other end thereof is inserted into the insulated base so as to make the second transmit pins electrically connect with the first transmit pins for signal transmission. By the insulator and the shielding body, the electromagnetic interference during signal transmission is suppressed. The present invention has simple structure, easy production process, and low manufacturing cost thus it's easy and convenient to produce board-to-board connectors with various heights.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a prior art of a board-to-board connector;

FIG. 2 is an assembling view of a board-to-board connector of a prior art disposed on a circuit board;

FIG. 3 is a perspective view of a board-to-board connector of another prior art.

FIG. 4 is a perspective view of an embodiment in accordance with the present invention;

FIG. 5A is a partial cross-sectional view of an plug in accordance with the present invention;

FIG. 5B is a cross-sectional view of the embodiment in FIG. 5A along A-A line;

FIG. 6 is an assembling view of an embodiment in accordance with the present invention disposed on a circuit board;

FIG. 7 is a perspective view showing the manufacturing of the plug in accordance with the present invention;

FIG. 8A is a perspective view of another embodiment in accordance with the present invention;

FIG. 8B is a cross-sectional view of the embodiment in FIG. 8A along B-B line.

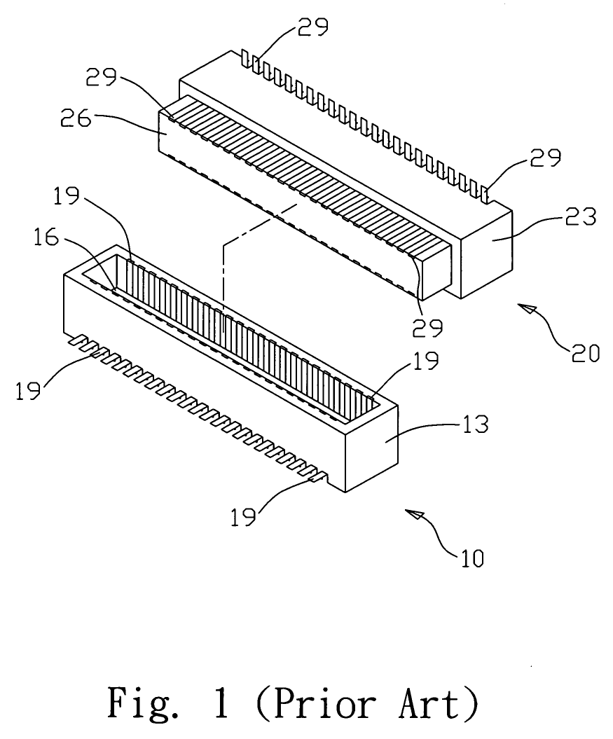

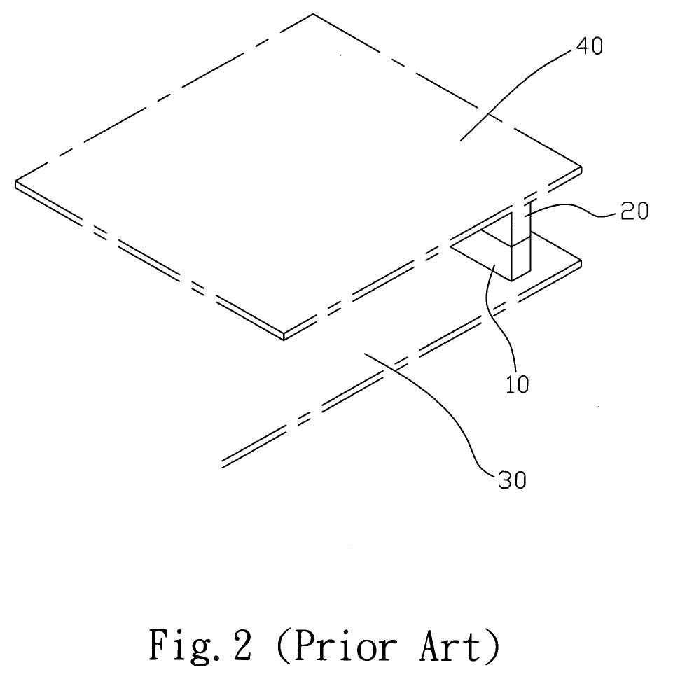

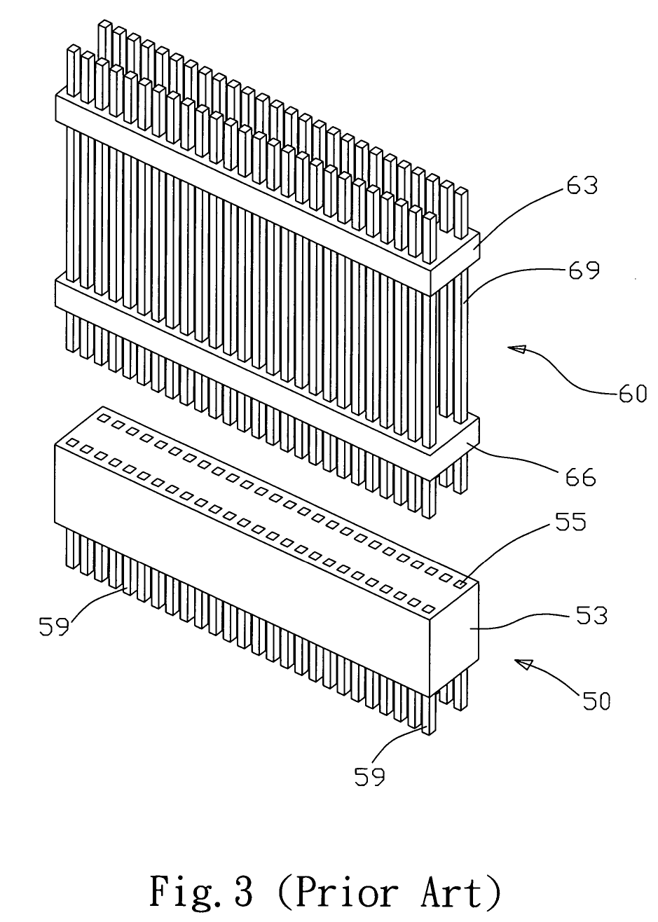

### DETAILED DESCRIPTION OF THE PREFFERED EMBODIMENT

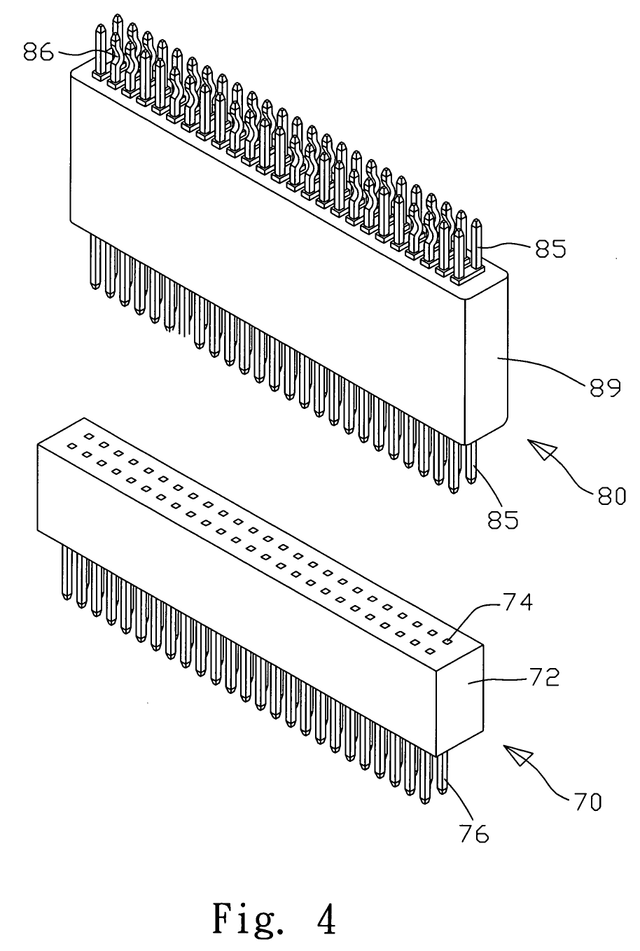

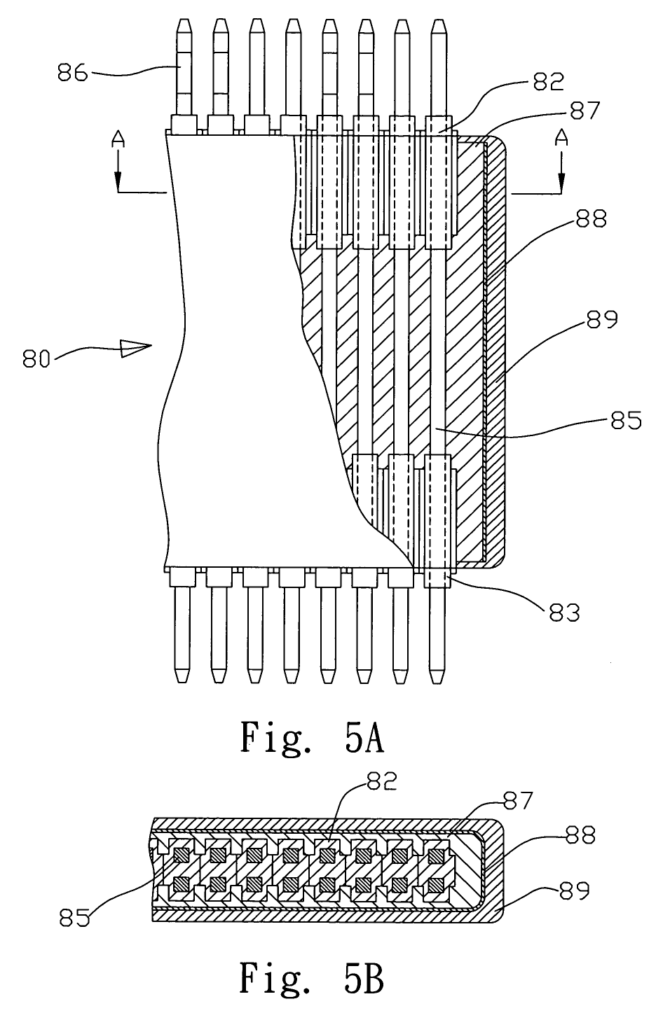

Refer to FIG. 4, FIG. 5A & FIG. 5B, a perspective view and partial cross-sectional view of a plug of an embodiment in accordance with the present invention are disclosed. A board-to-board connector of the present invention consists of a socket 70 and a plug 80. The socket 70 includes an insulated base 72 disposed with a plurality of insertion hole 74 and a plurality of first transmit pins 76. One end of the first transmit pins 76 is arranged inside the insertion hole 74 while the other end thereof is exposed outside the insulated base 72 for connection with a circuit board.

The plug 80 is formed by an upper fixing base 82 and a lower fixing base 83, both are insulator such as nylon base. A plurality of second transmit pins 85 is inserted through and disposed between the upper fixing base 82 and the lower fixing base 83. Upper part and lower part of the second transmit pins 85 are inserted through and exposed outside the upper fixing base 82 and the lower fixing base 83 respectively. The upper part of the second transmit pins 85 is used to connect with another circuit board. For the convenience of connection, a bent positioning part 86 is disposed on the upper part of the second transmit pins 85. Moreover, there is an insulator 87 filled between the upper and the lower part of the second transmit pins 85 and enclosed main bodies of each of the second transmit pins 85. That is, the main body of each second transmit pins 85 is separated with each other. The insulator 87 can be Nylon. A shielding body 88 covers the insulator 87 for shielding of electromagnetic waves and electromagnetic interference suppression. The shielding body 88 is made of metal such as aluminum foil. A housing 89 is arranged outside the shielding body 88.

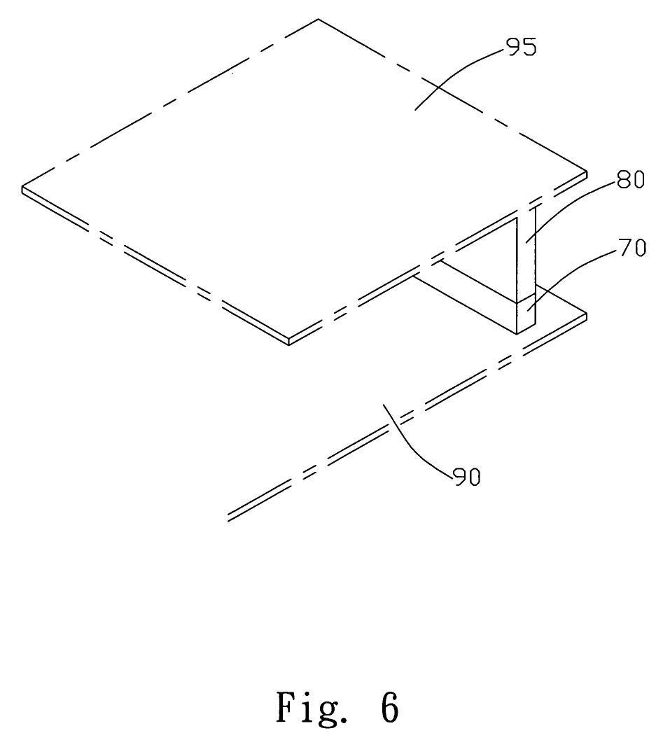

Refer to FIG. 6, the socket 70 of the board-to-board connector in accordance with the present invention is connected with and disposed on a first circuit board 90 by the first transmit pins 76 while the plug 80 is connected as well as arranged on a second circuit board 95 by the upper part of the second transmit pins 85. For the expansion of the first circuit board 90 and use of the second circuit board 95, the lower part of the second transmit pins 85 of the plug 80 inserts into the insertion hole 74 of the socket 70 so as to make the first transmit pins 76 contact with the second transmit pins 85. Thus signals are transmitted between the first circuit board 90 and the second circuit board 95.

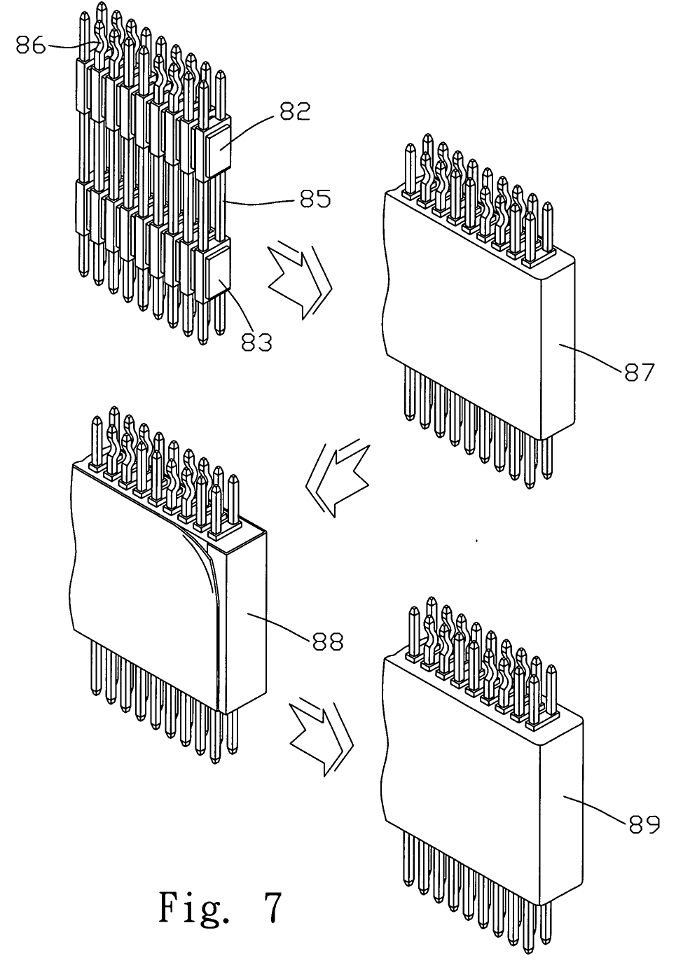

Refer to FIG. 7, manufacturing process of the present invention is disclosed. First, the second transmit pins 85 is positioned by either the upper fixing base 82 or the lower fixing base 83 respectively, or both. The bent positioning part 86 on the second transmit pins 85 is for the convenience of insertion of the second transmit pins 85 into the second circuit board 95. Furthermore, for the convenience of users to distinguish directions of the plug 80 between the socket 70 and the second circuit board 95, fixing bases with different colors are used. For example, the upper fixing base 82 is black while the lower fixing base 83 is ivory.

Then use insulator 87 to enclose the part between the upper part and lower part of the second transmit pins 85 so as to isolate main bodies of each second transmit pins 85 for avoiding interference. The next, the shielding body 88 covers the insulator 87 for electromagnetic interference suppression as well as better transmission quality during high-speed transmission. At last, the housing 89 surrounds the shielding body 88 so as to avoid damage of the plug 80 caused by external force.

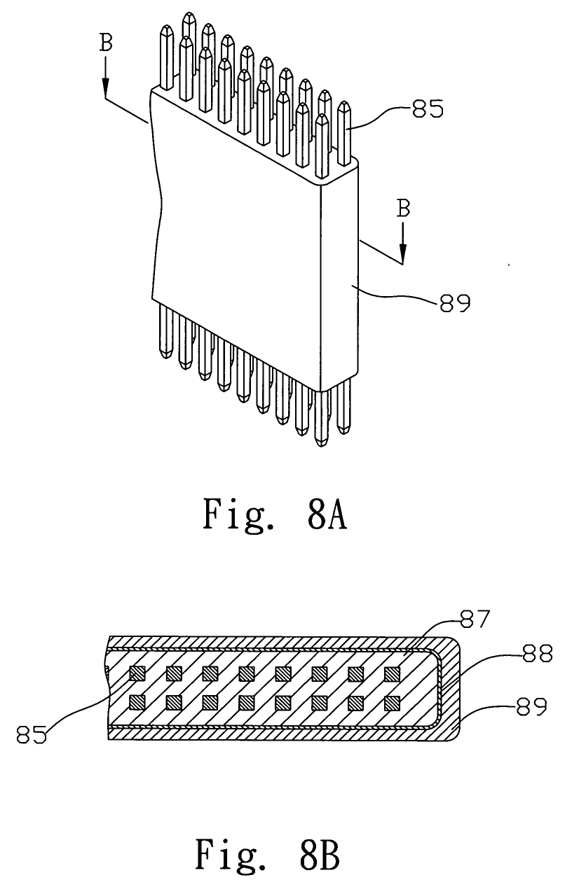

Refer to FIG. 8A & 8B, there is no fixing base 82 or the lower fixing base 83 of the present invention. A jig is used to align and position a plurality of second transmit pins 85. Then the insulator 87 covers main bodies of each second transmit pins 85 and the insulator 87 is enclosed by the shielding body as well as the housing 89 in sequence.

In summary, a board-to-board connector in accordance with the present invention has simple structure as well as manufacturing process so that it's easy to produce board-to-board connectors with various heights. Thus the production flexibility is higher than prior arts. Moreover, the plug of the present invention has effective electromagnetic interference suppression during high-speed transmission due to the insulator covered the second transmit pins and the shielding body surrounding the insulator.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A board-to-board connector comprising a socket and a plug; the socket comprising:
an insulated base;
a plurality of first transmit pins inserted through the insulated base; one end of the first transmit pins is used for connection with a first circuit board while the other end thereof is disposed on the insulated base;
the plug comprising:
a plurality of second transmit pins;
an insulator enclosing main body of each second transmit pins; and
a shielding body covering the insulator;
wherein one end of the second transmit pins is used for connection with a second circuit board while the other end thereof is inserted into the insulated base for electrical connection with the first transmit pin.

2. The device as claimed in claim 1, wherein the insulated base has a plurality of insertion holes for insertion of the second transmit pins.

3. The device as claimed in claim 1, wherein the plug further comprises at least one fixing base which the second transmit pins are disposed therein.

4. The device as claimed in claim 3, wherein the fixing base has an upper fixing base and a lower fixing base

5. The device as claimed in claim 3, wherein the fixing base is a nylon base.

6. The device as claimed in claim 1, wherein a bent positioning part is disposed on the second transmit pins of the plug for connecting the second transmit pins with the second circuit board.

7. The device as claimed in claim 1, wherein the insulator is nylon.

8. The device as claimed in claim 1, wherein the shielding body is a metal body.

9. The device as claimed in claim 8, wherein the metal body is aluminum foil.

10. The device as claimed in claim 1, wherein the plug further comprises a housing that encloses the shielding body.
